(19) United States
(12) Patent Application Publication
(10) Pub. No.: US 2025/0158517 A1
(43) Pub. Date: May 15, 2025

(54) CONTROL METHOD FOR RESONANT CONVERTER

(71) Applicant: Delta Electronics (Shanghai) Co., Ltd., Shanghai (CN)

(72) Inventors: Feidong Xu, Shanghai (CN); Bin Wang, Shanghai (CN); Xiaoping Wang, Shanghai (CN); Weiyi Zheng, Shanghai (CN)

(21) Appl. No.: 18/945,377

(22) Filed: Nov. 12, 2024

(30) Foreign Application Priority Data
Nov. 14, 2023 (CN) 202311515651.X

(51) Int. Cl. H02M 3/00; H02M 1/00; H02M 3/335

(52) U.S. Cl. CPC H02M 3/01; H02M 1/0058; H02M 3/33573; H02M 3/33584

(57) ABSTRACT

A control method for a resonant converter is provided. The primary-secondary phase shift angle is adjusted according to a variable dead zone. Consequently, the output current approaches to the reference current, and the deviation between the theoretical zero crossing value and the actual zero crossing value is reduced. In this way, the resonant converter of the present disclosure can be turned on in a zero-voltage switching manner within a wide voltage range.

### CROSS-REFERENCE TO RELATED APPLICATION

This application claims priority to China Patent Application No. 202311515651.X, filed on Nov. 14, 2023, the entire contents of which are incorporated herein by reference for all purposes.

### FIELD OF THE INVENTION

The present disclosure relates to a resonant converter, and more particularly to a control method for a resonant converter.

### BACKGROUND OF THE INVENTION

With the continuous technology development and the market drive of policies for smart microgrids, energy storage systems and electric vehicle systems, high-power dual-active bridge (DAB) converters have received widespread attention and application. Due to the rapid development of new power devices, high-frequency digital processing chips and high-frequency magnetic devices, the importance of high-power DAB converters is further highlighted. Generally, the high-power DAB converter has the advantages of electrical isolation, soft switching operation, high power density, high efficiency, bidirectional energy flow and high reliability.

FIGS. 1A and 1B are schematic timing waveform diagrams illustrating the theoretical current waveform and the actual current waveform of a conventional DAB converter. Generally, the actual current waveform also contains various harmonics in addition to the fundamental wave. When the existing DAB converter is operated within a wide voltage range, the actual zero-crossing point will be different from the theoretical zero-crossing point because of the difference between the theoretical current waveform Z1 and the actual current waveform Z2. Consequently, the DAB converter cannot realize zero-voltage switching within a wide voltage range, especially at voltage points with small ZVS margin.

Therefore, it is important to provide a control method for a resonant converter in order to overcome the drawbacks of the conventional technologies.

### SUMMARY OF THE INVENTION

In accordance with an aspect of the present disclosure, a control method for a resonant converter is provided. The resonant converter receives an input voltage and converts the input voltage into an output voltage. The resonant converter includes a primary side circuit, a resonant circuit, a transformer and a secondary side circuit. The resonant circuit is electrically connected between the primary side circuit and the transformer. The transformer is electrically connected between the resonant circuit and the secondary side circuit. In addition, all switches in the primary side circuit and the secondary side circuit are operated at a switching frequency. The control method includes the following steps. In a step (a), a voltage gain of the resonant converter is calculated, and a working mode of the resonant converter is determined. In a step (b), a time variate and a first variate are determined according to the voltage gain and the working mode, wherein a dead time is calculated according to the time variate and the first variate. In a step (c), a dead zone is calculated according to the dead time and the switching frequency. In a step (d), a primary-secondary phase shift angle, one of a primary phase shift angle and a secondary phase shift angle are calculated based on the dead zone and the voltage gain. In a step (e), the switches in the resonant converter are controlled according to the primary-secondary phase shift angle, the primary phase shift angle and the secondary phase shift angle.

In accordance with another aspect of the present disclosure, a control method for a resonant converter is provided. The resonant converter receives an input voltage and converts the input voltage into an output voltage. The resonant converter includes a primary side circuit, a resonant circuit, a transformer and a secondary side circuit. The resonant circuit is electrically connected between the primary side circuit and the transformer. The transformer is electrically connected between the resonant circuit and the secondary side circuit. In addition, all switches in the primary side circuit and the secondary side circuit are operated at a switching frequency. The control method includes the following steps. A voltage gain of the resonant converter is calculated according to the input voltage and the output voltage. The voltage gain is compared with a boundary value. If the voltage gain is greater than boundary value, a secondary phase shift angle is set to zero, and a variable dead zone between a primary phase shift angle and a primary-secondary phase shift angle is set. If the voltage gain is greater than 0 and less than or equal to the boundary value, the primary phase shift angle is set to zero, and the variable dead zone between the secondary phase shift angle and the primary-secondary phase shift angle is set.

The above contents of the present disclosure will become more readily apparent to those ordinarily skilled in the art after reviewing the following detailed description and accompanying drawings, in which:

### BRIEF DESCRIPTION OF THE DRAWINGS

FIGS. 1A and 1B are schematic timing waveform diagrams illustrating the theoretical current waveform and the actual current waveform of a conventional DAB converter;

FIG. 2 is a schematic circuit diagram illustrating a circuitry topology of a dual active bridge series resonant converter according to an embodiment of the present disclosure;

FIG. 3A is a flowchart illustrating a control method for the dual active bridge series resonant converter shown in FIG. 2;

FIG. 3B is a flowchart illustrating the detailed steps of a control method for the dual active bridge series resonant converter shown in FIG. 2;

FIG. 4 is a schematic circuit block diagram illustrating the operations of the dead zone calculation unit and the phase shift angle calculation unit in the control circuit of the dual active bridge series resonant converter shown in FIG. 2;

FIG. 5 is a schematic timing waveform diagram illustrating the driving signals for driving switches and associated voltage and current signals in the DAB series resonant converter shown in FIG. 2;

FIG. 6 is a schematic circuit diagram illustrating the current path of the DAB series resonant converter shown in FIG. 2;

FIG. 7 is a schematic circuit diagram illustrating the current path of the DAB series resonant converter shown in FIG. 2;

FIG. 8 is a schematic circuit diagram illustrating the current path of the DAB series resonant converter shown in FIG. 2;

FIG. 9 is a schematic circuit diagram illustrating the current path of the DAB series resonant converter shown in FIG. 2;

FIG. 10 is a schematic circuit diagram illustrating the current path of the DAB series resonant converter shown in FIG. 2;

FIG. 11 is a schematic circuit diagram illustrating the current path of the DAB series resonant converter shown in FIG. 2;

FIG. 12 is a schematic timing waveform diagram illustrating the driving signals for driving switches and associated voltage and current signals in the DAB series resonant converter shown in FIG. 2;

FIG. 13 is a schematic circuit diagram illustrating the current path of the DAB series resonant converter shown in FIG. 2;

FIG. 14 is a schematic circuit diagram illustrating the current path of the DAB series resonant converter shown in FIG. 2;

FIG. 15 is a schematic circuit diagram illustrating the current path of the DAB series resonant converter shown in FIG. 2;

FIG. 16 is a schematic circuit diagram illustrating the current path of the DAB series resonant converter shown in FIG. 2;

FIG. 17 is a schematic circuit diagram illustrating the current path of the DAB series resonant converter shown in FIG. 2;

FIG. 18 is a schematic circuit diagram illustrating the current path of the DAB series resonant converter shown in FIG. 2; and

FIG. 19 is a flowchart illustrating a control method for the dual active bridge series resonant converter shown in FIG. 2 according to another embodiment of the present disclosure.

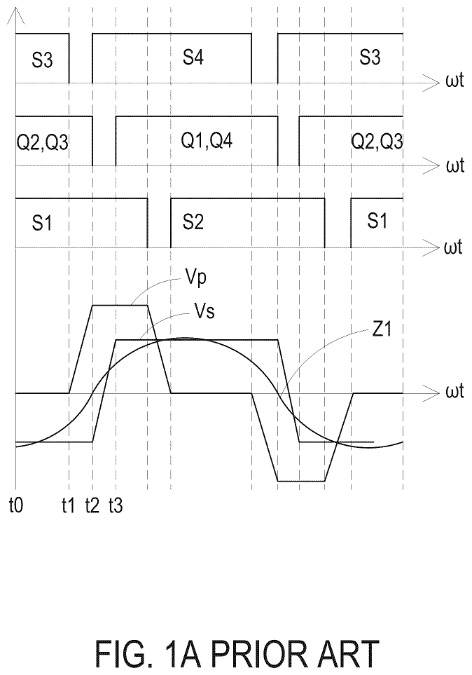

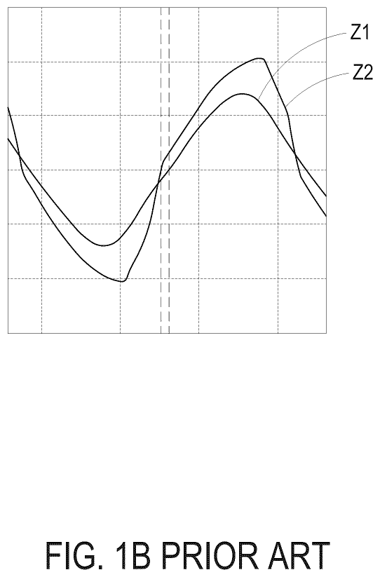

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

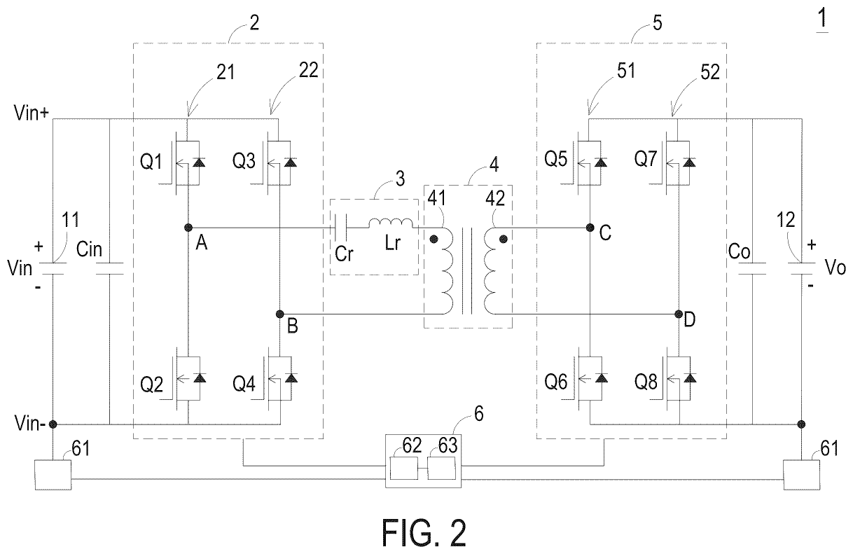

FIG. 2 is a schematic circuit diagram illustrating a circuitry topology of a dual active bridge series resonant converter according to an embodiment of the present disclosure. As shown in FIG. 2, the dual active bridge series resonant converter 1 (also referred as a DAB series resonant converter) includes a first port 11, a second port 12, an input capacitor Cin, a primary side circuit 2, a resonant circuit 3, a transformer 4, a secondary side circuit 5, an output capacitor Co and a control device 6.

The DAB series resonant converter 1 receives an input voltage Vin. For example, the DAB series resonant converter 1 receives the input voltage Vin through the first port 11. The first port 11 of the DAB series resonant converter 1 includes an input positive terminal Vin+ and an input negative terminal Vin−. The input voltage Vin is converted into an output voltage Vo by the DAB series resonant converter 1. The output voltage Vo is outputted from the second port 12. The second port 12 of the DAB series resonant converter 1 includes an output positive terminal Vo+ and an output negative terminal Vo−. The input capacitor Cin is electrically connected between the input positive terminal Vin+ and the input negative terminal Vin−.

The DAB series resonant converter 1 is a bidirectional converter. In another embodiment, the DAB series resonant converter 1 receives the input voltage from the second port 12. After the input voltage is converted into the output voltage by the DAB series resonant converter 1, the output voltage is outputted from the first port 11.

The primary side circuit 2 includes a first bridge arm 21 and a second bridge arm 22. The first bridge arm 21 is electrically connected with the input capacitor Cin in parallel. The first bridge arm 21 includes a first switch Q1 and a second switch Q2, which are connected with each other in series. The connection point between the first switch Q1 and the second switch Q2 is a first node A. In addition, the driving signals for controlling the first switch Q1 and the second switch Q2 are complementary to each other. A fixed dead zone is formed between the driving signals for turning on the first switch Q1 and the second switch Q2. The second bridge arm 22 is connected with the first bridge arm 21 in parallel. The second bridge arm 22 includes a third switch Q3 and a fourth switch Q4, which are connected with each other in series. The connection point between the third switch Q3 and the fourth switch Q4 is a second node B. In addition, the driving signals for controlling the third switch Q3 and the fourth switch Q4 are complementary to each other. A fixed dead zone is formed between the driving signals for turning on the third switch Q3 and the fourth switch Q4. In the primary side circuit 2, a primary phase shift angle φₚ is set between the first switch Q1 of the first bridge arm 21 and the fourth switch Q4 of the second bridge arm 22, or the primary phase shift angle φₚ is set between the second switch Q2 of the first bridge arm 21 and the third switch Q3 of the second bridge arm 22.

The resonant circuit 3 includes a resonant capacitor Cr and a resonant inductor Lr. The resonant capacitor Cr is electrically connected between the first node A and the resonant inductor Lr. The transformer 4 includes a primary winding 41 and a secondary winding 42. In addition, the transformer 4 has a transformation ratio n. The first terminal of the primary winding 41 is electrically connected with the resonant inductance Lr of the resonant circuit 3. The second terminal of the primary winding 41 is electrically connected with the second connection point B.

The secondary side circuit 5 includes a third bridge arm 51 and a fourth bridge arm 52. The third bridge arm 51 includes a fifth switch Q5 and a sixth switch Q6, which are connected with each other in series. The connection point between the fifth switch Q5 and the sixth switch Q6 is a third node C. The third node C is electrically connected with the first terminal of the secondary winding 42. In addition, the driving signals for controlling the fifth switch Q5 and the sixth switch Q6 are complementary to each other. A fixed dead zone is set between the driving signals for turning on the fifth switch Q5 and the sixth switch Q6. The fourth bridge arm 52 is connected with the third bridge arm 51 in parallel. The fourth bridge arm 52 includes a seventh switch Q7 and an eighth switch Q8, which are connected with each other in series. The connection point between the seventh switch Q7 and the eighth switch Q8 is a fourth node D. The fourth node D is electrically connected with the second terminal of the secondary winding 42. In addition, the driving signals for controlling the seventh switch Q7 and the eighth switch Q8 are complementary to each other. A fixed dead zone is set between the driving signals for turning on the seventh switch Q7 and the eighth switch Q8.

The output capacitor Co is connected with the third bridge arm 51 and the fourth bridge arm 52 in parallel. In the secondary side circuit 5, a secondary phase shift angle φₛ is set between the fifth switch Q5 of the third bridge arm 51 and the eighth switch Q8 of the fourth bridge arm 52, or the secondary phase shift angle φₛ is set between the sixth switch Q6 of the third bridge arm 51 and the seventh switch Q7 of the fourth bridge arm 52. The difference between the secondary phase shift angle φₛ and the primary phase shift angle φₚ is defined as a primary-secondary phase shift angle.

In an embodiment, all switches in the primary side circuit 2 and the secondary side circuit 5 of the DAB series resonant converter 1 are operated at a switching frequency fs.

It is noted that the example of the resonant converter of the present disclosure is not restricted to the DAB series resonant converter.

In accordance with a feature of the present disclosure, a dead zone aa is calculated according to a plurality of variates. The dead zone α_{d} is a variable dead zone. After the primary-secondary phase shift angle is adjusted according to the variable dead zone α_{d}, a compensated primary-secondary phase shift angle φₚₛ is obtained. Furthermore, after the variable dead zone α_{d} is subtracted from the compensated primary-secondary phase shift angle φₚₛ, the primary phase shift angle φₚ or the secondary phase shift angle φₛ is obtained. According to the compensated primary-secondary phase shift angle φₚₛ, the primary phase shift angle φₚ and the secondary phase shift angle φₛ, the operations of the switches in the primary side circuit 2 and the secondary side circuit 5 are correspondingly controlled. Since the influence of the deviation between the theoretical value and the actual value on the circuit control is reduced, the switches of the DAB converter can be turned on in a zero-voltage switching manner within a wide voltage range.

The control device 6 is configured to calculate the variable dead zone α_{d}. In addition, the control device 6 is configured to adjust the primary-secondary phase shift angle according to the variable dead zone α_{d}, thereby obtaining the compensated primary-secondary phase shift angle φₚₛ. The control device 6 is further configured to subtract the variable dead zone α_{d} from the compensated primary-secondary phase shift angle φₚₛ, to obtain the primary phase shift angle φₚ or the secondary phase shift angle φₛ. Furthermore, the control device 6 is configured to control the operation of the switches in the primary side circuit 2 and the secondary side circuit 5 according to the compensated primary-secondary phase shift angle φₚₛ, the primary phase shift angle φₚ and the secondary phase shift angle φₛ.

The control device 6 is electrically connected with a sampling circuit 61, the primary side circuit 2 and the secondary side circuit 5. The sampling circuit 61 is configured to obtain the input voltage Vin and the output voltage Vo of the resonant converter 1. In addition, the sampling circuit 61 provides the sampled signals of the input voltage Vin and the output voltage Vo to the control device 6. The control device 6 also receives the transformation ratio n of the transformer 4, the capacitance value of the resonant capacitor Cr and the inductance value of the resonant inductor Lr of the resonant circuit 3. In addition, the control device 6 calculates a voltage gain M according to the input voltage Vin, the output voltage Vo and the transformation ratio n of the transformer 4. According to the voltage gain M, a time variate, a first variate and a constant value, the control device 6 calculates the variable dead zone α_{d}. Furthermore, the control device 6 is configured to determine the working mode of the DAB series resonant converter 1 according to the voltage gain M and the energy flow direction between the first port 11 and the second port 12.

According to the energy flow direction between the first port 11 and the second port 12, the DAB series resonant converter 1 is selectively in a charging mode or a discharging mode. For example, the first port 11 is coupled to a DC bus (not shown), and the input voltage Vin inputted into the first port 11 is a DC bus voltage. The second port 12 is coupled to an energy storage unit (not shown), and the output voltage Vo from the second port 12 is an energy storage unit voltage. In case that the energy flows from the first port 11 to the second port 12, the DAB series resonant converter 1 operates in the charging mode. That is, the input voltage Vin of the first port 11 is converted into the output voltage Vo of the second port 2 to charge the energy storage unit. In case that the energy flows from the second port 12 to the first port 11, the DAB series resonant converter 1 operates in the discharging mode. That is, the input voltage Vin of the second port 12 is converted into the output voltage Vo, and the energy from the energy storage unit coupled to the second port 12 is discharged to the DC bus. When compared with the high-voltage DC bus, the energy storage unit is usually a low-voltage battery. Consequently, the high voltage is converted into the low voltage when the DAB series resonant converter 1 operates in the charging mode, and the low voltage is converted into the high voltage when the DAB series resonant converter 1 operates in the discharging mode.

In an embodiment, the control device 6 includes a control circuit 62 and a driving circuit 63. For example, the control circuit 62 is a DSP control chip. The control circuit 62 is used to convert the sampled voltage signals of the input voltage Vin and the output voltage Vo. Furthermore, the control circuit 62 generates PWM driving signals according to a ZVS phase shift control method and a variable dead zone setting method in a full load range. Since all switches can be turned on in a zero-voltage switching manner in the full load range, the circuit loss, the current peak value, the circuit conduction loss and the circulating current loss are reduced, and the current stresses of the switches and the diodes are reduced. The driving circuit 63 is electrically connected with the control circuit 62. The driving circuit 63 receives the PWM driving signals from the control circuit 62. After isolation and voltage enhancement, the driving circuit 63 provides driving signals for the switches (Q1, Q2, Q3, Q4, Q5, Q6, Q7 and Q8) in the primary side circuit 2 and the secondary side circuit 5.

A method for obtaining the variable dead zone α_{d}, the primary phase shift angle φₚ, the secondary phase shift angle φₛ and the primary-secondary phase shift angle φₚₛ will be described in more details as follows.

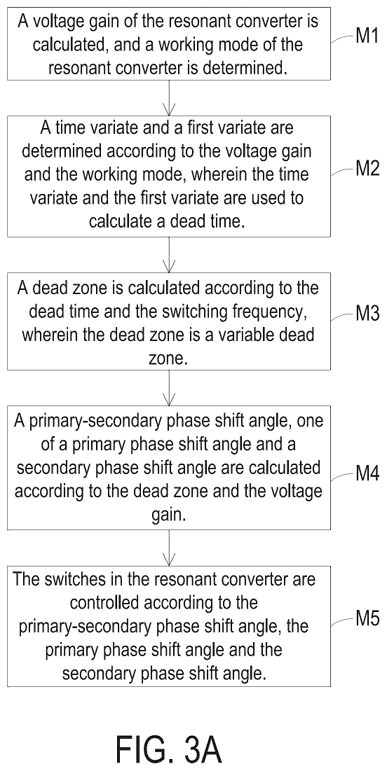

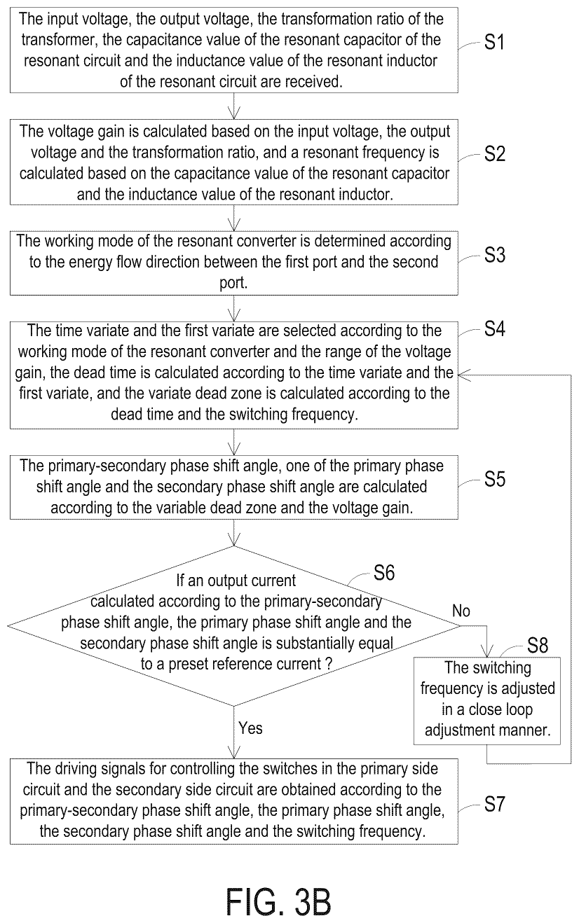

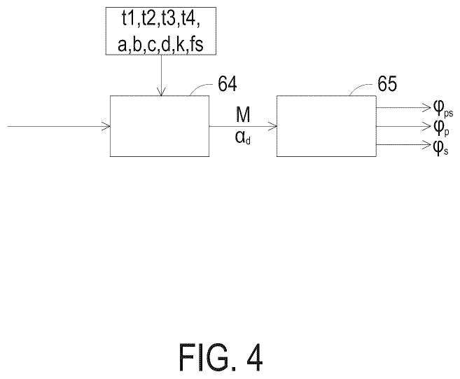

Please refer to FIG. 2, FIG. 3A, FIG. 3B and FIG. 4. FIG. 3A is a flowchart illustrating a control method for the dual active bridge series resonant converter shown in FIG. 2. FIG. 3B is a flowchart illustrating the detailed steps of a control method for the dual active bridge series resonant converter shown in FIG. 2. FIG. 4 is a schematic circuit block diagram illustrating the operations of a dead zone calculation unit and a phase shift angle calculation unit in the control circuit of the dual active bridge series resonant converter shown in FIG. 2.

Please refer to FIG. 3A. In a step M1, a voltage gain M of the resonant converter 1 is calculated, and a working mode of the resonant converter 1 is determined. In a step M2, a time variate and a first variate are determined according to the voltage gain M and the working mode, wherein the time variate and the first variate are used to calculate a dead time ta. In a step M3, the dead zone is calculated according to the dead time t_{d} and the switching frequency. The dead zone is a variable dead zone α_{d}. In a step M4, the primary-secondary phase shift angle φₚₛ, one of the primary phase shift angle φₚ and the secondary phase shift angle φₛ are calculated according to the dead zone and the voltage gain M. In a step M5, the switches in the resonant converter 1 are controlled according to the primary-secondary phase shift angle φₚₛ, the primary phase shift angle φₚ and the secondary phase shift angle φₛ.

The detailed steps of the control method for the resonant converter 1 will be described with reference to FIG. 3B. The control device 6 is configured to perform steps S1˜S7. In a step S1, the input voltage Vin, the output voltage Vo, the transformation ratio n of the transformer 4, the capacitance value of the resonant capacitor Cr of the resonant circuit 3 and the inductance value of the resonant inductor Lr of the resonant circuit 3 are received. In a step S2, the voltage gain M is calculated based on the input voltage Vin, the output voltage Vo and the transformation ratio n, and a resonant frequency fr is calculated based on the capacitance value of the resonant capacitor Cr and the inductance value of the resonant inductor Lr. For example, the voltage gain M and the resonant frequency fr are calculated according to the formula (1) and the formula (2):

$$M = n V o / V in \qquad ( 1 )$$

$$fr = \frac{1}{2 π \sqrt{Lr * Cr}} \qquad ( 2 )$$

The energy flow direction between the first port 11 and the second port 12 is recognized. In a step S3, the working mode of the DAB series resonant converter 1 is determined according to the energy flow direction between the first port 11 and the second port 12. If the control device 6 recognizes that the energy flows from the first port 11 to the second port 12, the control device 6 determines that the DAB series resonant converter 1 operates in the charging mode. If the control device 6 recognizes that the energy flows from the second port 12 to the first port 11, the control device 6 determines that the DAB series resonant converter 1 operates in the discharging mode.

In a step S4, the time variate and the first variate are selected according to the working mode of the DAB series resonant converter 1 (i.e., the charging mode or the discharging mode) and the range of the voltage gain M. Consequently, the dead time t_{d} is calculated. Then, the variable dead zone α_{d} is calculated according to the dead time t_{d} and the switching frequency fs. As shown in FIG. 4, the control circuit 62 further includes a dead zone calculation unit 64 to perform the step S4. In the step S4, the dead zone calculation unit 64 determines the time variate and the first variate according to the working mode of the DAB series resonant converter 1 and the voltage gain M, and the dead time t_{d} is calculated according to the time variate and the first variate. Then, the variable dead zone α_{d} is calculated according to the dead time t_{d} and the switching frequency fs. The method for selecting the time variate and the first variate will be described later.

In a step S5, the control circuit 62 calculates the primary-secondary phase shift angle φₚₛ, one of the primary phase shift angle φₚ and the secondary phase shift angle φₛ according to the variable dead zone α_{d} and the voltage gain M. The control circuit 62 sets the other one of the primary phase shift angle φₚ and the secondary phase shift angle φₛ to zero. As shown in FIG. 4, the control circuit 62 further includes a phase shift angle calculation unit 65. The phase shift angle calculation unit 65 is coupled to the dead zone calculation unit 64 to perform the step S5. The phase shift angle calculation unit 65 receives the variable dead zone od. In addition, the phase shift angle calculation unit 65 calculates and outputs the primary-secondary phase shift angle φₚₛ, one of the primary phase shift angle φₚ and the secondary phase shift angle φₛ according to the variable dead zone α_{d} and the voltage gain M.

In a step S6, an output current Iₒ is calculated according to the primary-secondary phase shift angle φₚₛ, the primary phase shift angle φₚ and the secondary phase shift angle φₛ. In addition, the control device 6 determines whether the magnitude of the output current Iₒ is equal to a preset reference current I_{ref}.

If the determining result of the step S6 indicates that the output current Iₒ is substantially equal to a preset reference current I_{ref}, a step S7 is performed. For example, the magnitude of the output current Iₒ is substantially equal to a preset reference current I_{ref}. In an embodiment, the output current is a normalized output current. In the step S7, the driving signals for controlling the switches Q1˜Q4 in the primary side circuit 2 and the switches Q5˜Q8 in the secondary side circuit 5 are obtained according to the primary-secondary phase shift angle φₚₛ, the primary phase shift angle φₚ, the secondary phase shift angle φₛ and the switching frequency fs.

If the determining result of the step S6 indicates that the magnitude of the output current Iₒ is not substantially equal to a preset reference current I_{ref}, a step S8 is performed. For example, the magnitude of the output current Iₒ is not substantially equal to a preset reference current I_{ref}. In the step S8, the switching frequency fs is adjusted. For example, the switching frequency fs is adjusted in a close loop adjustment manner. Then, the step S4 is repeatedly done.

The step S4 of calculating the dead time and the step S5 of calculating the primary-secondary phase shift angle φₚₛ, one of the primary phase shift angle φₚ and the secondary phase shift angle φₛ according to the working mode of the DAB series resonant converter 1 (i.e., the charging mode or the discharging mode) and the voltage gain M will be described in more details as follows.

When the boundary conditions are taken into consideration, the hysteresis control mechanism is adopted for the switching action at M=1. As the voltage gain M increases, the voltage gain M is in the rising edge. If the voltage gain M is greater than a first boundary value, it is determined to be in the situation of voltage gain M>1. If the voltage gain M is greater than 0 and less than or equal to the first boundary value, it is determined to be in the situation of 0<M<=1. The first boundary value is greater than 1. In addition, the first boundary value may be flexibly adjusted according to the practical requirements. For example, the first boundary value is equal to 1.02.

As the voltage gain M decreases, the voltage gain M is in the falling edge. If M is greater than a second boundary value, it is determined to be in the situation of M>1. When the voltage gain M is greater than 0 and less than or equal to the second boundary value, it is determined to be in the situation of 0<M<=1. The second boundary value is less than 1. In addition, the second boundary value may be flexibly adjusted according to the practical requirements. For example, the second boundary value is equal to 0.98.

In a first situation, the DAB series resonant converter 1 operates in the discharging mode, and the voltage gain M is less than or equal to a boundary value and greater than 0. In case that the time variate is t1 and the first variate is a, the variable dead time t_{d} can be calculated according to the following formula (3-1), and the variable dead zone α_{d} can be calculated according to the following formula (3-2):

$${t}_{d} = t 1 * ( max ( a , M ) \hat{} k ) \qquad ( 3 - 1 )$$

$${α}_{d} = 2 π * fs * t 1 * ( max ( a , M ) \hat{} k ) \qquad ( 3 - 2 )$$

In the above formulae, k is a constant value greater than or equal to 1, and the value of k may be varied according to the practical requirements. The time variate t1 is an adjustable time value, and the time variate t1 is greater than 1. The first variate a is an adjustable value, and the first variate a is greater than 0 and less than 1.

The primary-secondary phase shift angle φₚₛ is obtained according to the voltage gain M and the variable dead zone α_{d}. In addition, the primary-secondary phase shift angle φₚₛ is calculated according to the following formula (3-3). In consequence, the primary-secondary phase shift angle has been compensated in the first situation.

$${φ}_{ps} = max ( {α}_{d} , arcsin \sqrt{1 - min ( 1 , M )} ) \qquad ( 3 - 3 )$$

After the variable dead zone α_{d} is subtracted from the primary-secondary phase shift angle φₚₛ, the primary phase shift angle φₚ is obtained. In the first situation, the secondary phase shift angle φₛ is zero.

In a second situation, the DAB series resonant converter 1 operates in the charging mode, and the voltage gain M is less than or equal to the boundary value and greater than 0. In case that the time variate is t2 and the first variate is b, the variable dead time t_{d} can be calculated according to the following formula (4-1), and the variable dead zone α_{d} can be calculated according to the following formula (4-2):

$${t}_{d} = t 2 * ( max {( b , M )}^{⋀} k ) \qquad ( 4 - 1 )$$

$${α}_{d} = 2 π * fs * t 2 * ( max {( b , M )}^{⋀} k ) \qquad ( 4 - 2 )$$

In the above formulae, the time variate t2 is an adjustable time value, and the time variate t2 is greater than 1. The first variate b is an adjustable value, and the first variate b is greater than 0 and less than 1.

The primary-secondary phase shift angle φₚₛ is obtained according to the voltage gain M and the variable dead zone α_{d}. In addition, the primary-secondary phase shift angle φₚₛ is calculated according to the following formula (4-3). In consequence, the primary-secondary phase shift angle φₚₛ has been compensated in the second situation.

$${φ}_{ps} = max ( {α}_{d} , arcsin \sqrt{1 - min ( 1 , M )} + α t 2 ) \qquad ( 4 - 3 )$$

After the variable dead zone α_{d} is subtracted from the primary-secondary phase shift angle φₚₛ, the primary phase shift angle φₚ is obtained. In the second situation, the secondary phase shift angle φₛ is zero.

The boundary value can be equal to 1. The boundary value can be larger than 1, such as 1.02. The boundary value can be smaller than 1, such as 0.98.

When the boundary conditions are taken into consideration, the hysteresis control mechanism is adopted for the switching action at M=1. As the voltage gain M increases, the voltage gain M is in the rising edge. The boundary value is larger than 1, such as 1.02. As the voltage gain M decreases, the voltage gain M is in the falling edge. The boundary value is smaller than 1, such as 0.98.

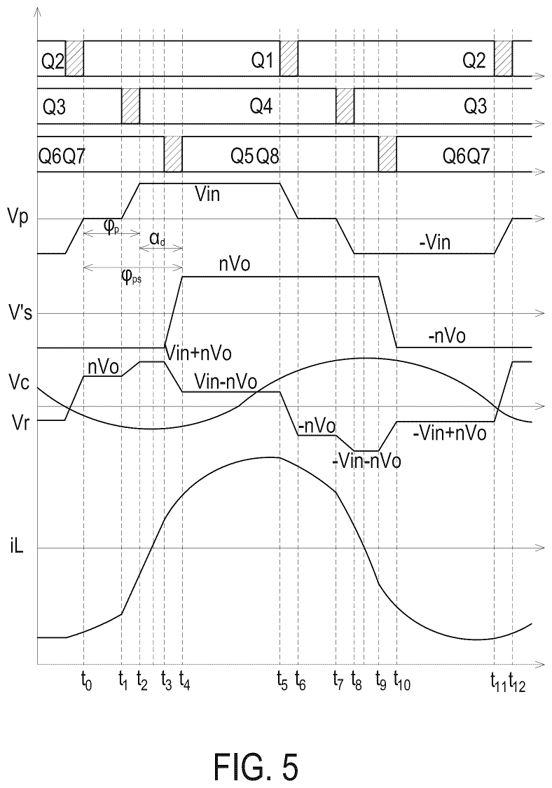

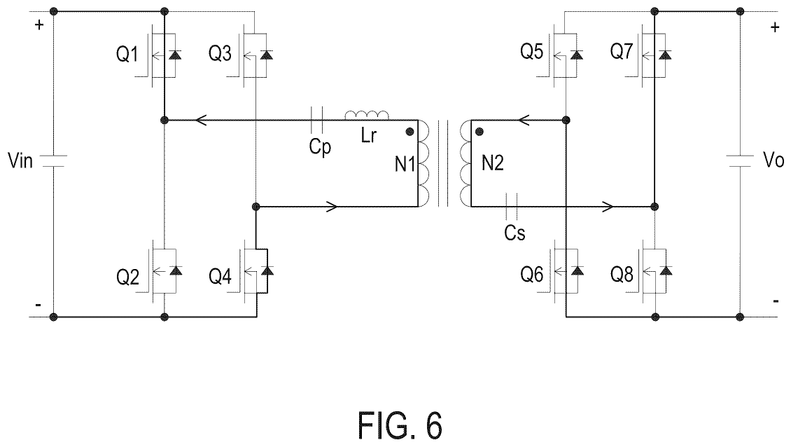

FIG. 5 is a schematic timing waveform diagram illustrating the driving signals for driving switches and associated voltage and current signals in the DAB series resonant converter shown in FIG. 2. FIGS. 6 to 11 are schematic circuit diagrams illustrating current paths of the DAB series resonant converter shown in FIG. 2. In FIGS. 6 to 11, the voltage gain is less than or equal to 1 and greater than 0.

In FIG. 5, the voltage Vp is the voltage between the first node A and the second node B of the DAB series resonant converter shown in FIG. 2, and V's is the voltage between the third node C and the fourth node D of the DAB series resonant converter shown in FIG. 2. The operations of the DAB series resonant converter will be illustrated with reference to FIGS. 5 to 11.

Please refer to FIG. 5 and FIG. 6. At the time point t₁, the third switch Q3 is turned off. In the time interval t₁˜t₂, the inductor current decreases in the reverse direction, and the current flows through the anti-parallel diode of the fourth switch Q4. At the time point t2, the primary phase shift angle φₚ is reached, and the fourth switch Q4 is turned on. The voltage across the fourth switch Q4 is essentially zero when the fourth switch Q4 is turned on.

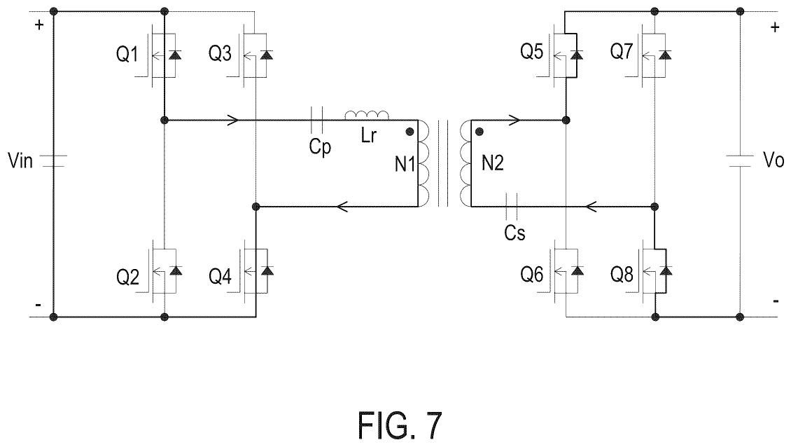

Please refer to FIG. 5 and FIG. 7. At the time point t₃, the sixth switch Q6 and the seventh switch Q7 are turned off. In the time interval t₃˜t₄, the inductor current increases in the forward direction, and the current flows through the anti-parallel diodes of the fifth switch Q5 and the eighth switch Q8. At the time point t₄, the variable dead zone α_{d} is reached, and the fifth switch Q5 and the eighth switch Q8 are turned on. The voltages across the fifth switch Q5 and the eighth switch Q8 are essentially zero when the fifth switch Q5 and the eighth switch Q8 are turned on.

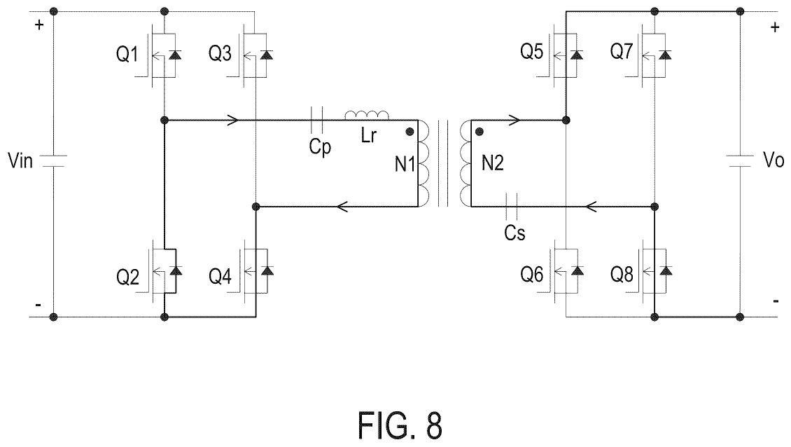

Please refer to FIG. 5 and FIG. 8. At the time point t₅, the first switch Q1 is turned off. In the time interval t₅˜t₆, the inductor current decreases in the forward direction, and the current flows through the anti-parallel diode of the second switch Q2. At the time point t₆, the primary-secondary phase shift angle φₚₛ is reached, and the second switch Q2 is turned on. The voltages across the second switch Q2 is essentially zero when the second switch Q2 is turned on. The primary-secondary phase shift angle φₚₛ is equal to the primary phase shift angle φₚ superimposed on the variable dead zone dd. Since the variable dead zone α_{d} is adjusted, the fourth switch Q4, the fifth switch Q5, the eighth switch Q8 and the second switch Q2 are turned on in the zero-voltage switching manner.

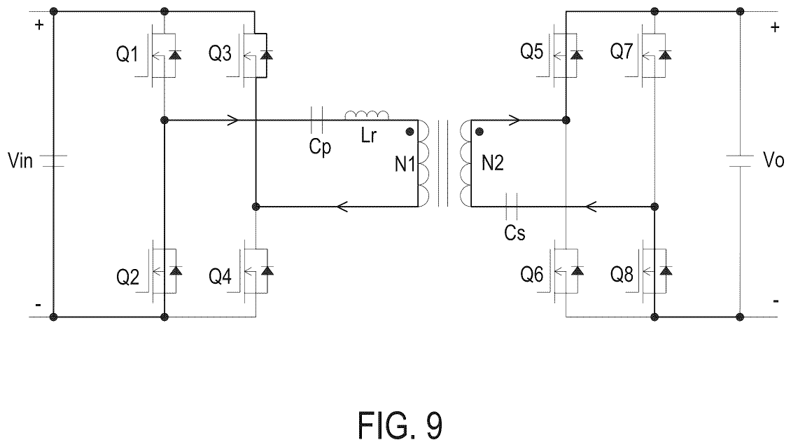

Please refer to FIG. 5 and FIG. 9. At the time point t₇, the fourth switch Q4 is turned off. In the time interval t₇˜t₈, the inductor current decreases in the forward direction, and the current flows through the anti-parallel diode of the third switch Q3. At the time point t₈, the primary phase shift angle φₚ is reached, and the third switch Q3 is turned on. The voltage across the third switch Q3 is essentially zero when the third switch Q3 is turned on.

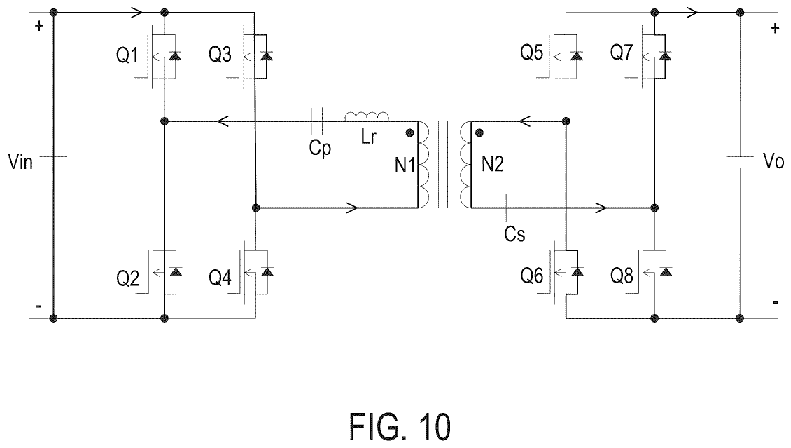

Please refer to FIG. 5 and FIG. 10. At the time point t₉, the fifth switch Q5 and the eighth switch Q8 are turned off. In the time interval t₉˜t₁₀, the inductor current increases in the reverse direction, and the current flows through the anti-parallel diodes of the sixth switch Q6 and the seventh switch Q7. At the time point t₁₀, the variable dead zone α_{d} is reached, and the sixth switch Q6 and the seventh switch Q7 are turned on. The voltages across the sixth switch Q6 and the seventh switch Q7 are essentially zero when the sixth switch Q6 and the seventh switch Q7 are turned on.

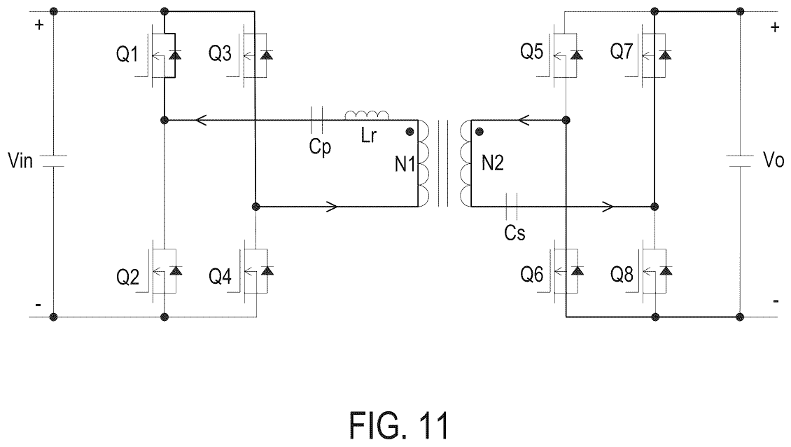

Please refer to FIG. 5 and FIG. 11. At the time point t₁₁, the second switch Q2 is turned off. In the time interval t₁₁˜t₁₂, the inductor current decreases in the reverse direction, and the current flows through the anti-parallel diode of the first switch Q1. At the time point t₁₂, the primary-secondary phase shift angle φₚₛ is reached, and the first switch Q1 is turned on. The voltage across the first switch Q1 is essentially zero when the first switch Q1 is turned on. The primary-secondary phase shift angle φₚₛ is equal to the primary phase shift angle φₚ superimposed on the variable dead zone ad. Since the variable dead zone α_{d} is adjusted, the third switch Q3, the sixth switch Q6, the seventh switch Q7 and the first switch Q1 are turned on in the zero-voltage switching manner.

In a third situation, the DAB series resonant converter 1 operates in the discharging mode, and the voltage gain M is greater than a boundary value. In case that the time variate is t3 and the first variate is c, the dead time t_{d} can be calculated according to the following formula (5-1), and the variable dead zone α_{d} can be calculated according to the following formula (5-2):

$${t}_{d} = t 3 * ( max {( c , 1 / M )}^{⋀} k ) \qquad ( 51 - 1 )$$

$${α}_{d} = 2 π * fs * t 3 * ( max {( c , 1 / M )}^{⋀} k ) \qquad ( 51 - 2 )$$

In the above formulae, the time variate t3 is an adjustable time value, and the time variate t3 is greater than 1. The first variate c is an adjustable value, and the first variate c is greater than 0 and less than 1.

The primary-secondary phase shift angle φₚₛ is obtained according to the voltage gain M and the variable dead zone α_{d}. In addition, the primary-secondary phase shift angle φₚₛ is calculated according to the following formula (5-3). In consequence, the primary-secondary phase shift angle φₚₛ has been compensated in the third situation.

$${φ}_{ps} = max ( {α}_{d} , arcsin \sqrt{1 - min ( 1 , 1 / M )} + α t 2 ) \qquad ( 5 - 3 )$$

In this situation, the primary phase shift angle φₚ is zero. After the variable dead zone α_{d} is subtracted from the primary-secondary phase shift angle φₚₛ, the secondary phase shift angle φₛ is obtained.

In a fourth situation, the DAB series resonant converter 1 operates in the charging mode, and the voltage gain M is greater than the boundary value. In case that the time variate is t4 and the first variate is d, the dead time t_{d} can be calculated according to the following formula (6-1), and the variable dead zone α_{d} can be calculated according to the following formula (6-2):

$${t}_{d} = t 4 * ( max {( d , 1 / M )}^{⋀} k ) \qquad ( 6 - 1 )$$

$${α}_{d} = 2 π * fs * t 4 * ( max {( d , 1 / M )}^{⋀} k ) \qquad ( 6 - 2 )$$

In the above formulae, the time variate t4 is an adjustable time value, and the time variate t4 is greater than 1. The first variate d is an adjustable value, and the first variate d is greater than 0 and less than 1.

The primary-secondary phase shift angle φₚₛ is obtained according to the voltage gain M and the variable dead zone α_{d}. In addition, the primary-secondary phase shift angle φₚₛ is calculated according to the following formula (62). In consequence, the primary-secondary phase shift angle φₚₛ has been compensated in the forth situation.

$${φ}_{ps} = max ( {α}_{d} , asin \sqrt{1 - min ( 1 , 1 / M )} ) \qquad ( 62 )$$

In this situation, the primary phase shift angle φₚ is zero. After the variable dead zone α_{d} is subtracted from the primary-secondary phase shift angle φₚₛ, the secondary phase shift angle φₛ is obtained.

The boundary value can be equal to 1. The boundary value can be larger than 1, such as 1.02. The boundary value can be smaller than 1, such as 0.98.

When the boundary conditions are taken into consideration, the hysteresis control mechanism is adopted for the switching action at M=1. As the voltage gain M increases, the voltage gain M is in the rising edge. The boundary value is larger than 1, such as 1.02. As the voltage gain M decreases, the voltage gain M is in the falling edge. The boundary value is smaller than 1, such as 0.98.

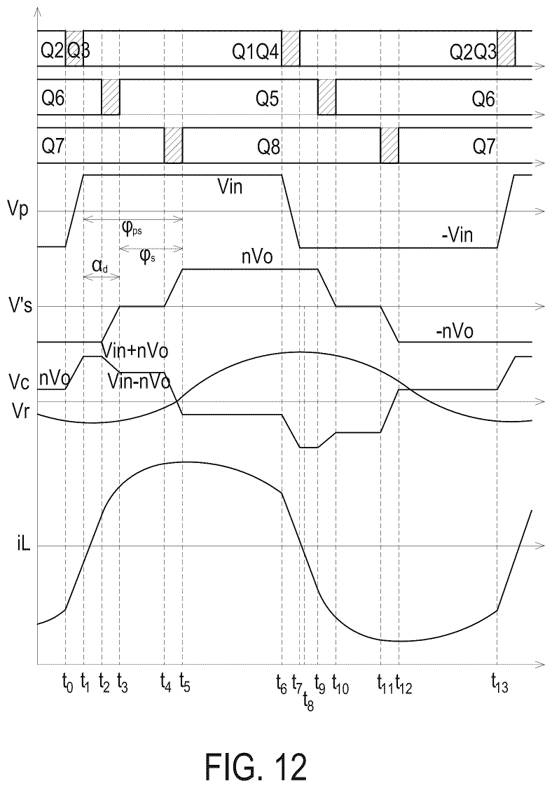

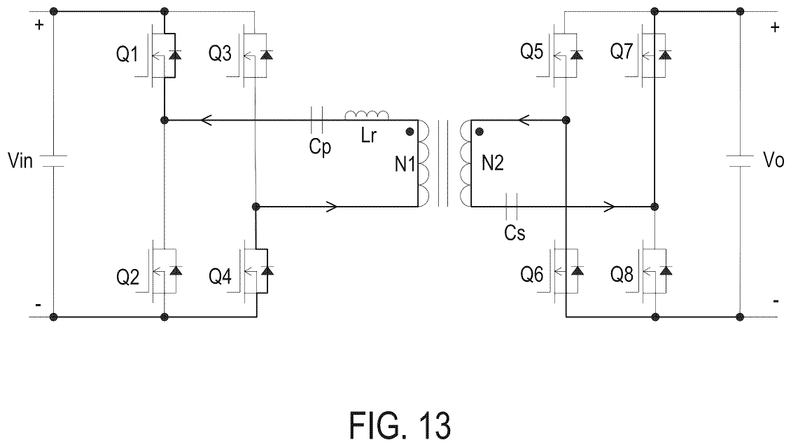

FIG. 12 is a schematic timing waveform diagram illustrating the driving signals for driving switches and associated voltage and current signals in the DAB series resonant converter shown in FIG. 2. FIGS. 13 to 18 are schematic circuit diagrams illustrating current paths of the DAB series resonant converter shown in FIG. 2. In FIGS. 12 to 18, the voltage gain is greater than 1.

Please refer to FIG. 12 and FIG. 13. At the time point t₀, the third switch Q3 and the second switch Q2 are turned off. In the time interval t₀˜t₁, the inductor current decreases in the reverse direction, and the current flows through the anti-parallel diodes of the first switch Q1 and the fourth switch Q4. At the time point t₁, a fixed dead zone is reached, and the first switch Q1 and the fourth switch Q4 are turned on. The voltage across the first switch Q1 and the fourth switch Q4 are essentially zero when the first switch Q1 and the fourth switch Q4 are turned on.

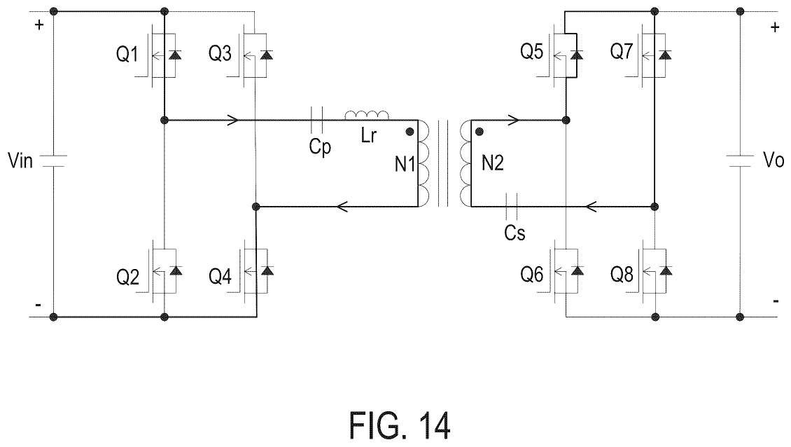

Please refer to FIG. 12 and FIG. 14. At the time point t₂, the sixth switch Q6 is turned off. In the time interval t₂˜t₃, the inductor current increases in the forward direction, and the current flows through the anti-parallel diode of the fifth switch Q5. At the time point t₃, the variable dead zone α_{d} is reached, and the fifth switch Q5 is turned on. The voltages across the fifth switch Q5 is essentially zero when the fifth switch Q5 is turned on.

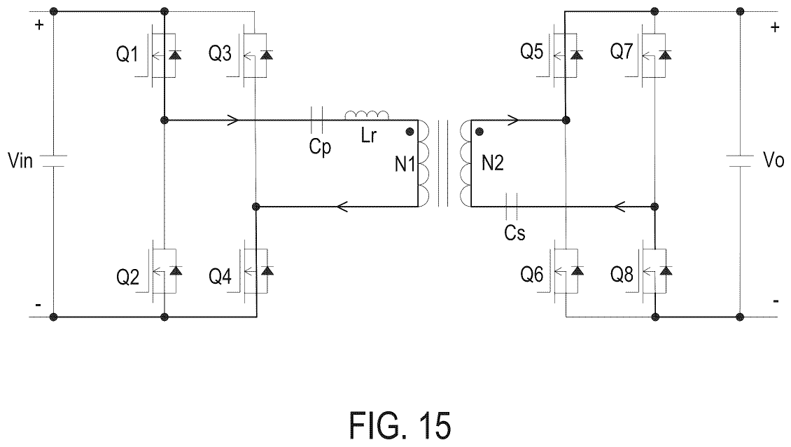

Please refer to FIG. 12 and FIG. 15. At the time point t₄, the seventh switch Q7 is turned off. In the time interval t₄˜t₅, the inductor current increases in the forward direction, and the current flows through the anti-parallel diode of the eighth switch Q8. At the time point t₅, the secondary phase shift angle φₛ is reached, and the eighth switch Q8 is turned on. The voltage across the eighth switch Q8 is essentially zero when the eighth switch Q8 is turned on. The primary-secondary phase shift angle φₚₛ is equal to the secondary phase shift angle φₛ superimposed on the variable dead zone α_{d}. Since the variable dead zone α_{d} is adjusted, the first switch Q1, the fourth switch Q4, the fifth switch Q5 and the eighth switch Q8 are turned on in the zero-voltage switching manner.

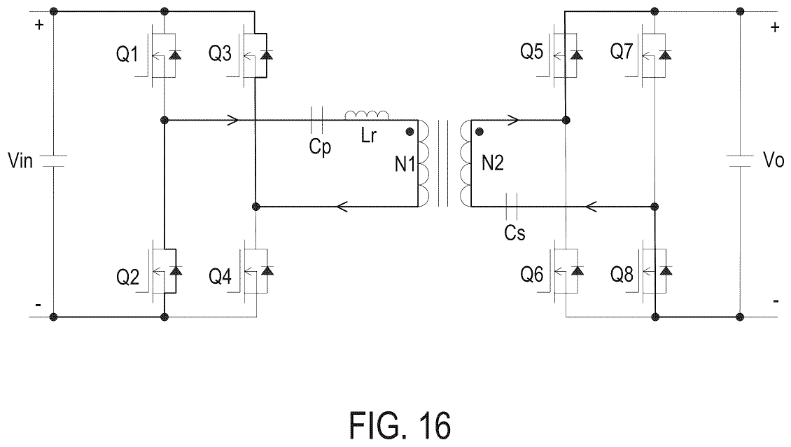

Please refer to FIG. 12 and FIG. 16. At the time point t₆, the first switch Q1 and the fourth switch Q4 are turned off. In the time interval t₆˜t₇, the inductor current decreases in the forward direction, and the current flows through the anti-parallel diodes of the third switch Q3 and the second switch Q2. At the time point t₇, the primary-secondary phase shift angle φₚₛ is reached, and the third switch Q3 and the second switch Q2 are turned on. The voltages across the third switch Q3 and the second switch Q2 are essentially zero when the third switch Q3 and the second switch Q2 are turned on.

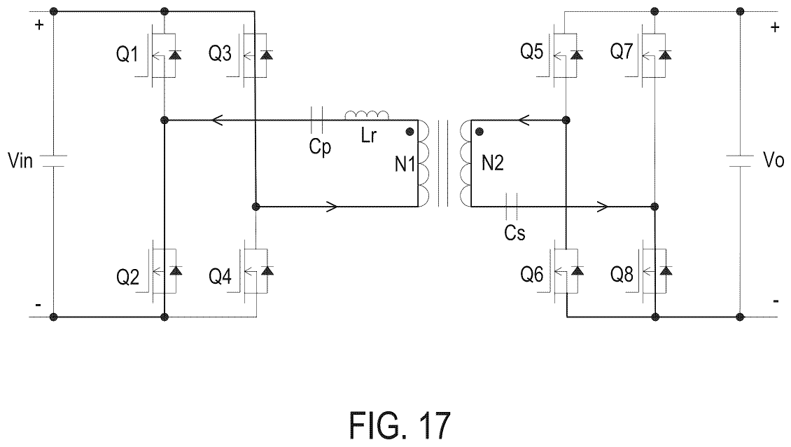

Please refer to FIG. 12 and FIG. 17. At the time point t₉, the fifth switch Q5 is turned off. In the time interval t₉˜t₁₀, the inductor current increases in the reverse direction, and the current flows through the anti-parallel diode of the sixth switch Q6. At the time point t₁₀, the variable dead zone α_{d} is reached, and the seventh switch Q7 is turned on. The voltage across the sixth switch Q6 is essentially zero when the sixth switch Q6 is turned on.

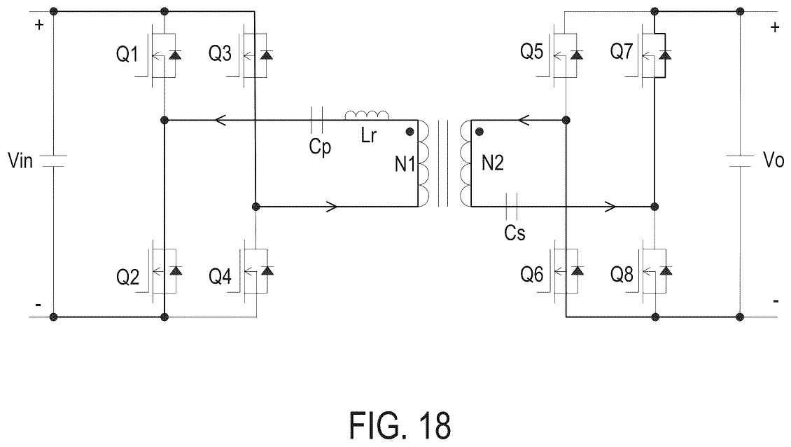

Please refer to FIG. 12 and FIG. 18. At the time point t₁₁, the eighth switch Q8 is turned off. In the time interval t₁₁˜t₁₂, the inductor current increases in the reverse direction, and the current flows through the anti-parallel diode of the seventh switch Q7. At the time point t₁₂, the secondary phase shift angle φₛ is reached, and the seventh switch Q7 is turned on. The voltage across the seventh switch Q7 is essentially zero when the seventh switch Q7 is turned on. The primary-secondary phase shift angle φₚₛ is equal to the secondary phase shift angle φₛ superimposed on the variable dead zone α_{d}. Since the variable dead zone α_{d} is adjusted, the third switch Q3, the second switch Q2, the sixth switch Q6 and the seventh switch Q7 are turned on in the zero-voltage switching manner.

The appropriate variable dead zone can be obtained through the adjustment of the eight variates t1, t2, t3, t4, a, b, c and d. Each of the four variates t1, t2, t3 and t4 is greater than 0 and may be flexibly adjusted according to the practical requirements. Each of the four variates a, b, c and d is greater than 0 and less than 1, and may be flexibly adjusted according to the practical requirements.

In the step S6, the output current Iₒ is calculated according to the following formula (63), and determine by the control device 6 whether the output current Iₒ is equal to the preset reference current I_{ref}.

$${I}_{o} = \frac{8 {n}^{2} {V}_{o}^{2}}{{π}^{2} {P}_{o} \sqrt{\frac{Lr}{Cr}} ( \frac{fs}{fr} - \frac{fr}{fs} )} cos ( \frac{{φ}_{p}}{2} ) cos ( \frac{{φ}_{s}}{2} ) sin ( {φ}_{ps} ) \qquad ( 63 )$$

In the above formula, Pₒ is the output power of the DAB series resonant converter 1, and fs is the switching frequency.

The boundary condition of the voltage gain M is not restricted to be in the range between 0 and 1. For example, the voltage gain M is in the range between 0 and 0.98, or the voltage gain M is in the range between 0 and 1.02.

In some embodiment, one or more steps are implemented by the control device 6.

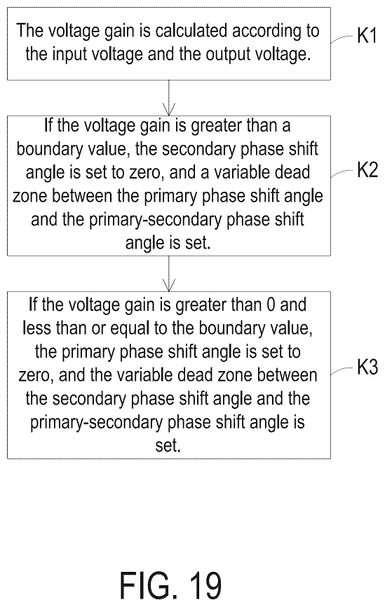

Please refer to FIG. 2 and FIG. 19. FIG. 19 is a flowchart illustrating a control method for the dual active bridge series resonant converter shown in FIG. 2 according to another embodiment of the present disclosure. In a step K1, the voltage gain M is calculated according to the input voltage Vin and the output voltage Vo. If the voltage gain M is greater than a boundary value, a step K2 is performed. That is, the secondary phase shift angle φₛ is adjusted to zero, and a variable dead zone α_{d} between the primary phase shift angle φₚ and the primary-secondary phase shift angle φₚₛ is set. If the voltage gain M is greater than 0 and less than or equal to the boundary value, a step K3 is performed. That is, the primary phase shift angle φₚ is adjusted to zero, and a variable dead zone α_{d} between the secondary phase shift angle φₛ and the primary-secondary phase shift angle φₚₛ is set. The boundary value can be equal to 1. The boundary value can be larger than 1, such as 1.02. The boundary value can be smaller than 1, such as 0.98.

From the above descriptions, the present disclosure provides a control method for a resonant converter. According to the working mode and the voltage gain, a variable dead time and a corresponding variable dead zone are calculated. Then, the primary-secondary phase shift angle is compensated through the variable dead zone. One of a primary phase shift angle and a secondary phase shift angle is obtained based on the compensated primary-secondary phase shift angle. The other one of the primary phase shift angle and the secondary phase shift angle is set to zero.

Consequently, the control device controls the operations of the switches in the primary side circuit and the secondary side circuit according to the primary phase shift angle, the secondary phase shift angle and the primary-secondary phase shift angle. Consequently, the output current approaches to the preset reference current. In the control method of the present disclosure, the variable dead zone is adjustable, so that the primary-secondary phase shift angle is adjustable according to the variable dead zone, and the primary phase shift angle or the secondary phase shift angle is adjustable according to the variable dead zone. Consequently, the output current approaches to the preset reference current, and the deviation between the theoretical zero crossing value and the actual zero crossing value is reduced. In this way, the resonant converter of the present disclosure can operate in the zero-voltage switching manner within a wide voltage range. The control flexibility of the resonant converter is enhanced, and the control complexity of the resonant converter is reduced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control method for a resonant converter, the resonant converter receiving an input voltage and converting the input voltage into an output voltage, the resonant converter comprising a primary side circuit, a resonant circuit, a transformer and a secondary side circuit, the resonant circuit being electrically connected between the primary side circuit and the transformer, the transformer being electrically connected between the resonant circuit and the secondary side circuit, all switches in the primary side circuit and the secondary side circuit being operated at a switching frequency, the control method comprising steps of:
(a) calculating a voltage gain of the resonant converter, and determining a working mode of the resonant converter;
(b) determining a time variate and a first variate according to the voltage gain and the working mode, wherein a dead time is calculated according to the time variate and the first variate;
(c) calculating a dead zone according to the dead time and the switching frequency;
(d) calculating a primary-secondary phase shift angle, one of a primary phase shift angle and a secondary phase shift angle based on the dead zone and the voltage gain; and
(e) controlling the switches in the resonant converter according to the primary-secondary phase shift angle, the primary phase shift angle and the secondary phase shift angle.

2. The control method according to claim 1, wherein the time variate and the first variate are adjustable, so that the dead zone calculated is a variable dead zone.

3. The control method according to claim 1, wherein the step (a) further comprising:
receiving the input voltage, the output voltage and a transformation ratio of the transformer, and calculating the voltage gain according to the input voltage, the output voltage and the transformation ratio; and
determining the working mode of the resonant converter according to an energy flow direction of the resonant converter.

4. The control method according to claim 1, wherein the step (e) further comprising:
calculating an output current according to the primary-secondary phase shift angle, the primary phase shift angle and the secondary phase shift angle, and determining whether the output current is substantially equal to a reference current;
when the output current is substantially equal to the reference current, obtaining driving signals for controlling the switches in the primary side circuit and the secondary side circuit according to the primary-secondary phase shift angle, the primary phase shift angle, the secondary phase shift angle and the switching frequency; and
when the output current is not substantially equal to the reference current, adjusting the switching frequency.

5. The control method according to claim 1, wherein the voltage gain is greater than 0 and less than or equal to a boundary value, and the secondary phase shift angle is zero.

6. The control method according to claim 5, wherein when the voltage gain is in a rising edge, the boundary value is greater than 1; and when the voltage gain is in a falling edge, the boundary value is less than 1.

7. The control method according to claim 5, wherein when determining the resonant converter operates in a discharging mode, the dead time and the dead zone are calculated according to following formulae:
$${t}_{d} = t 1 * ( max {( a , M )}^{⋀} k )$$
$${α}_{d} = 2 π * fs * t 1 * ( max {( a , M )}^{⋀} k )$$
wherein t_{d} is the dead time, α_{d} is the dead zone, fs is the switching frequency, M is the voltage gain, k is a constant value greater than or equal to 1, t₁ is the time variate, and a is the first variate, wherein the time variate is an adjustable time value, and the first variate is an adjustable value.

8. The control method according to claim 7, wherein the primary-secondary phase shift angle and the primary phase shift angle are calculated according to following formulae:
$${φ}_{ps} = max ( {α}_{d} , arcsin \sqrt{1 - min ( 1 , M )} )$$
$${φ}_{p} = {φ}_{ps} - {α}_{d}$$
wherein φₚₛ is the primary-secondary phase shift angle, and φₚ is the primary phase shift angle.

9. The control method according to claim 5, wherein when determining the resonant converter operates in a charging mode, the dead time and the dead zone are calculated according to following formulae:
$${t}_{d} = t 2 * ( max {( b , M )}^{⋀} k )$$
$${α}_{d} = 2 π * fs * t 1 * ( max {( a , M )}^{⋀} k )$$
wherein t_{d} is the dead time, α_{d} is the dead zone, fs is the switching frequency, M is the voltage gain, k is a constant value greater than or equal to 1, t2 is the time variate, and b is the first variate, wherein the time variate is an adjustable time value greater than 1, and the first variate is an adjustable value greater than 0 and less than 1.

10. The control method according to claim 9, wherein the primary-secondary phase shift angle and the primary phase shift angle are calculated according to following formulae:
$${φ}_{ps} = max ( {α}_{d} , arcsin \sqrt{1 - min ( 1 , M )} + α t 2 )$$
$${φ}_{p} = {φ}_{ps} - {α}_{d}$$
wherein φₚₛ is the primary-secondary phase shift angle, and φₚ is the primary phase shift angle.

11. The control method according to claim 1, wherein the voltage gain is greater than a boundary value, and the primary phase shift angle is zero.

12. The control method according to claim 11, wherein when the voltage gain is in a rising edge, the boundary value is greater than 1; and when the voltage gain is in a falling edge, the boundary value is less than 1.

13. The control method according to claim 11, wherein when determining the resonant converter operates in a discharging mode, the dead time and the dead zone are calculated according to following formulae:
$${t}_{d} = t 3 * ( max {( c , 1 / M )}^{⋀} k )$$
$${α}_{d} = 2 π * fs * t 1 * ( max {( c , M )}^{⋀} k )$$
wherein t_{d} is the dead time, α_{d} is the dead zone, fs is the switching frequency, M is the voltage gain, k is a constant value greater than or equal to 1, t3 is the time variate, and c is the first variate, wherein the time variate is an adjustable time value, and the first variate is an adjustable value.

14. The control method according to claim 13, wherein the primary-secondary phase shift angle and the secondary phase shift angle are calculated according to following formulae:
$${φ}_{ps} = max ( {α}_{d} , arcsin \sqrt{1 - min ( 1 , 1 / M )} + α t 2 )$$
$${φ}_{s} = {φ}_{ps} - {α}_{d}$$
wherein φₚₛ is the primary-secondary phase shift angle, and φₛ is the secondary phase shift angle.

15. The control method according to claim 11, wherein when determining the resonant converter operates in a charging mode, the dead time and the dead zone are calculated according to following formulae:
$${t}_{d} = t 4 * ( max {( d , 1 / M )}^{⋀} k )$$
$${α}_{d} = 2 π * fs * t 1 * ( max {( a , M )}^{⋀} k )$$
wherein t_{d} is the dead time, α_{d} is the dead zone, fs is the switching frequency, M is the voltage gain, k is a constant value greater than or equal to 1, t4 is the time variate, and d is the first variate, wherein the time variate is an adjustable time value, and the first variate is an adjustable value.

16. The control method according to claim 15, wherein the primary-secondary phase shift angle and the secondary phase shift angle are calculated according to following formulae:
$${φ}_{ps} = max ( {α}_{d} , asin \sqrt{1 - min ( 1 , 1 / M )} )$$
$${φ}_{s} = {φ}_{ps} - {α}_{d}$$
wherein φₚₛ is the primary-secondary phase shift angle, and φₛ is the secondary phase shift angle.

17. A control method for a resonant converter, the resonant converter receiving an input voltage and converting the input voltage into an output voltage, the resonant converter comprising a primary side circuit, a resonant circuit, a transformer and a secondary side circuit, the resonant circuit being electrically connected between the primary side circuit and the transformer, the transformer being electrically connected between the resonant circuit and the secondary side circuit, all switches in the primary side circuit and the secondary side circuit being operated at a switching frequency, the control method comprising steps of:
(a) calculating a voltage gain of the resonant converter according to the input voltage and the output voltage; and
(b) comparing the voltage gain with a boundary value,
wherein when the voltage gain is greater than the boundary value, set a secondary phase shift angle to zero and a variable dead zone between a primary phase shift angle and a primary-secondary phase shift angle; and
wherein when the voltage gain is greater than 0 and less than or equal to the boundary value, set the primary phase shift angle to zero and the variable dead zone between the secondary phase shift angle and the primary-secondary phase shift angle.

18. The control method according to claim 17, wherein in the step (b), the primary-secondary phase shift angle and one of the primary phase shift angle and the secondary phase shift angle are calculated according to the variable dead zone and the voltage gain.

19. The control method according to claim 17, wherein a variable dead time is calculated according to a time variate, a first variate and the voltage gain, and the variable dead zone is calculated according to the variable dead time and the switching frequency.

20. The control method according to claim 19, wherein the time variate is an adjustable time value, and the first variate is an adjustable value, so that the variable dead zone is adjustable.
